(19) United States
(12) Patent Application Publication
(10) Pub. No.: US 2011/0266286 A1
(43) Pub. Date: Nov. 3, 2011

(54) Afterflow Reservoir for a Hydraulic Actuating Device and Hydraulic Actuating Device

(75) Inventors: Werner Schmauder, Huelben (DE); Bernd Nenning, Ichenhausen (DE)

(73) Assignee: Gustav Magenwirth GmbH & Co. KG, Bad Urach (DE)

(21) Appl. No.: 13/114,798

(22) Filed: May 24, 2011

Related U.S. Application Data
(63) Continuation of application No. PCT/EP2009/065937, filed on Nov. 26, 2009.

(30) Foreign Application Priority Data
Nov. 27, 2008 (DE) 10 2008 060 165.9

(51) Int. Cl. B62D 33/00

(52) U.S. Cl. 220/562

(57) ABSTRACT

In order to provide an afterflow reservoir for a hydraulic actuating device, in particular for a clutch or brake actuating device of motor vehicles, comprising an outlet which can be connected to an actuating cylinder, a container body rising above the outlet and having a storage chamber provided in it for holding hydraulic fluid as well as an air chamber located above a fluid level limiting the storage chamber, with which any intake of air bubbles into the actuating cylinder can be reduced, if not avoided, it is suggested that a separating unit extending at a distance from the fluid level be arranged in the storage chamber, this separating unit dividing the storage chamber into an intake chamber bordering on the outlet and a reserve chamber located between the separating unit and the fluid level, and that hydraulic fluid be able to enter the intake chamber from the reserve chamber through at least one connection between the reserve chamber and the intake chamber.

### CROSS REFERENCE TO RELATED APPLICATIONS

This application is a continuation of international application number PCT/EP2009/065937 filed on Nov. 26, 2009.

This patent application claims the benefit of International application No. PCT/EP2009/065937 of Nov. 26, 2009 and German application No. 10 2008 060 165.9 of Nov. 27, 2008, the teachings and disclosure of which are hereby incorporated in their entirety by reference thereto.

### BACKGROUND OF THE INVENTION

The invention relates to an afterflow reservoir for a hydraulic actuating device as well as a hydraulic actuating device, in particular a clutch or brake actuating device for motor vehicles.

Hydraulic actuating device with an afterflow reservoir, in which a hydraulic fluid is stored such that when there is any decrease in the hydraulic fluid this can run on into the actuating device each time.

Furthermore, the afterflow reservoir is also preferably arranged such that bubbles forming in the actuating device can exit into the afterflow reservoir and, therefore, their volume will be replaced by hydraulic fluid running on from the reservoir so that any impairment of the action of the actuating device on account of the compressibility of the air in the bubbles can be avoided.

Such an afterflow reservoir is normally provided with an outlet which can be connected to an actuating cylinder and has a container body rising above the outlet with a storage chamber provided in it for holding hydraulic fluid as well as an air chamber which is located above a fluid level limiting the storage chamber.

Such an air chamber in the afterflow reservoir is necessary to provide the possibility of being able to check the state of the fluid level and, therefore, the filling level of the afterflow reservoir simply via a window.

The presence of such an air chamber does, however, have the disadvantage that vibrations, in particular vibrations of high-speed engines, which are transferred to the hydraulic actuating device, result in air bubbles being formed in the hydraulic fluid which, together with the hydraulic fluid, result in a type of emulsion and, therefore, the hydraulic fluid will form a foam at least in the area of the fluid level.

Such foaming of the hydraulic fluid makes this unsuitable for any follow-up run or follow-up flow of hydraulic fluid into the actuating device since, as a result, a considerable risk also exists of air bubbles reaching the actuating cylinder and, as a result, of the action of the actuating device being impaired.

The object underlying the invention is, therefore, to provide an afterflow reservoir for a hydraulic actuating device, with which any intake of air bubbles into the actuating cylinder can be reduced, if not avoided.

### SUMMARY OF THE INVENTION

This object is accomplished in accordance with the invention, in an afterflow reservoir of the type described at the outset, in that a separating unit is arranged in the storage chamber and this unit extends at a distance from the fluid level present in the normal, due operating state and divides the storage chamber into an intake chamber bordering on the outlet and a reserve chamber located between the separating unit and the fluid level and that hydraulic fluid can enter the intake chamber from the reserve chamber through at least one connection between the reserve chamber and the intake chamber.

The advantage of the solution according to the invention is to be seen in the fact that the possibility is given, as a result of the separating unit, of keeping the foam forming in the reserve chamber, in particular close to the fluid level, and the emulsion consisting of air bubbles and hydraulic fluid resulting therefrom essentially away from the intake chamber and, therefore, of reducing the probability of air bubbles being sucked in by the actuating cylinder.

In principle, the connection between the reserve chamber and the intake chamber could be arranged at any optional location, in particular at any optional location of the separating unit.

However, in order to reduce the probability of air bubbles being conveyed into the intake chamber from the reserve chamber by the hydraulic fluid, it is preferably provided for the connection to be arranged close to the base of the reserve chamber.

This arrangement of the connection has, on the one hand, the advantage that, as a result, hydraulic fluid can run on into the intake chamber to the greatest possible extent even when the level of the afterflow reservoir falls below a predetermined minimum filling quantity and, on the other hand, since the probability of air bubbles propagating as far as into the area of the reserve chamber close to the base is reduced, the advantage that the probability of air bubbles being conveyed from the reserve chamber into the intake chamber is also reduced as a result.

On the other hand, as already mentioned, air bubbles also exit from the actuating cylinder and pass into the intake chamber via the outlet.

In order to be able to remove such air bubbles collecting in the intake chamber from this chamber, it is preferably provided for the separating unit to have an exit opening for bubbles which opens into the reserve chamber.

Such a bubble exit opening is preferably arranged such that it is located in an area close to or in the intake chamber which is arranged next to the fluid level so that bubbles occurring in the intake chamber collect in the area of the bubble exit opening.

In order to guide essentially all the bubbles rising in the intake chamber to the bubble exit opening, it is preferably provided for the separating unit to have a bubble guiding surface which guides bubbles rising in the intake chamber to the bubble exit opening.

This means that the bubble guiding surface always conveys the rising bubbles to the bubble exit opening in order to prevent a larger amount of rising bubbles collecting in the intake chamber.

In this respect, the bubble guiding surface is preferably designed such that, proceeding from an edge area which is at a maximum distance from the fluid level, it extends as far as the bubble exit opening with an ever decreasing distance from the fluid level and, therefore, causes the rising bubbles to migrate constantly along the bubble guiding surface on account of the buoyant force acting on them and, as a result, to reach the bubble exit opening.

In this respect, the bubble exit opening is arranged, in particular, at a spot on the bubble guiding surface which is located closest to the fluid level.

So that, in particular, all the bubbles entering the intake chamber from the actuating cylinder through the outlet are guided to the bubble exit opening, it is preferably provided for the separating unit to engage over the outlet with its bubble guiding surface.

In this respect, it is particularly favorable when the bubble exit opening is arranged in an area of the separating unit which is at a distance from the outlet in a direction parallel to the fluid level.

With respect to the design of the connection between the reserve chamber and the intake chamber, no further details have so far been given.

In the simplest case, it is provided for the connection to lead from the reserve chamber directly to the intake chamber.

In order, in addition, to reduce the probability of hydraulic fluid, which is flowing from the reserve chamber into the intake chamber, transporting air bubbles into the intake chamber, it is preferably provided for the connection to comprise a settling chamber for hydraulic fluid flowing to the intake chamber so that the hydraulic fluid flows first of all from the reserve chamber into the settling chamber and then from the settling chamber into the intake chamber.

This solution may be realized particularly favorably in that the settling chamber is separated from the reserve chamber by the separating unit.

In order to be able to convey bubbles out of both the settling chamber and the intake chamber, it is preferably provided for both the settling chamber and the intake chamber to extend as far as the bubble guiding surface so that rising bubbles may be discharged from both the settling chamber and the intake chamber.

In principle, it would be conceivable to provide a bubble exit opening not only for the settling chamber but also for the intake chamber so that the bubble guiding surfaces can each be directed to different bubble exit openings.

One advantageous embodiment provides for the bubble guiding surface to guide the rising bubbles to the bubble exit opening not only with its area engaging over the intake chamber but also with its area engaging over the settling chamber.

In order to provide the possibility, in the area of the bubble exit opening, of collecting bubbles before they pass through the bubble exit opening, it is preferably provided for the intake chamber to merge into a bubble collection chamber which is arranged in the area of the bubble exit opening.

Furthermore, it is likewise preferably provided for the settling chamber to merge into a bubble collection chamber which is arranged in the area of the bubble exit opening.

With respect to the design of the separating unit no further details have so far been given.

One advantageous solution, for example, provides for the separating unit to have a cover forming the bubble guiding surface.

In this respect, it is favorable, in particular, when the cover of the separating unit is part of an insert member which is inserted into the container body so that the cover can be mounted in a simple manner as a result.

Furthermore, it is preferably provided for the separating unit to have side walls, wherein the side walls preferably lead from a container base to the cover.

The side walls could also be provided on an insert member or also be provided on the cover and be insertable into the container body with it.

Another advantageous solution provides, however, for at least one side wall of the separating unit to be integrally formed on the container body.

It is particularly favorable when all the side walls of the separating unit are integrally formed on the container body.

In the case of a settling chamber which is provided in addition to the intake chamber, it is preferably provided for the separating unit to separate the intake chamber and the settling chamber from the reserve chamber.

In order to likewise be able to separate the intake chamber and the settling chamber from one another, it is preferably provided for them to be separated from one another by at least one dividing element.

In this respect, it is particularly favorable when the at least one dividing element extends from the container base as far as the bubble guiding surface so that it can be ensured that bubbles from the settling chamber do not enter the intake chamber.

In order, in particular, to reduce or prevent the formation of foam in the area of the reserve chamber, an additional advantageous solution provides for a fluid retaining element to be arranged in the reserve chamber.

Such a fluid retaining element serves the purpose of preventing free movement of the fluid and keeping the fluid as motionless as possible relative to the container body.

This is brought about, in particular, in that the fluid retaining element divides the volume for the brake fluid into small-volume storage areas, wherein small-volume storage areas of this type have a volume which is at the most 0.5 cm³, better at the most 0.2 cm³ or even more advantageous at the most 0.1 cm³ and therefore causes a strong coupling of the fluid to the container body.

Such a fluid retaining element is produced, in particular, from a braided material, a knitted material, a knit fabric or a woven fabric which is either laid in folds or statistically folded and, therefore, fills the reserve chamber as far as possible.

In this respect, the braided material, the knitted material, the knit fabric or woven fabric can consist, for example, of fibers or threads or strands of metal or plastic.

Alternatively hereto, another advantageous solution provides for the fluid retaining element to be produced from an open-pored and large-pored body, for example consisting of carbon fibers, plastic or metal, which likewise creates the possibility of providing small-volume storage areas for the brake fluid, wherein these small-volume storage areas are, however, likewise in communication with one another so that the brake fluid—when necessary—can flow through unhindered.

An alternative or, where applicable, also additional advantageous solution provides for volume dividers to be provided in the reserve chamber.

Such volume dividers are, for example, wall elements, webs or columns which are, for example, integrally formed on a support, wherein the support is, again, connected to the container body.

For example, such volume dividers may be integrally formed either on the container body, the separating unit or a lid of the container body.

Such volume dividers also preferably serve the purpose of dividing the volume for the brake fluid into partial volumes and thus of reducing the formation of foam.

A particular advantage of such volume dividers is that they are preferably aligned such that they let, preferably even allow, bubbles to rise in a direction contrary to the force of gravity. However, the volume dividers are arranged, in particular, such that they prevent any propagation of the bubbles transversely to the direction of the force of gravity and, therefore, contribute to reducing or even preventing the formation of foam in the reserve chamber.

Alternatively or in addition to the provision of a fluid retaining element in the reserve chamber, a further, advantageous solution provides for a fluid retaining element to be arranged in the intake chamber and/or the settling chamber.

A fluid retaining element in the intake chamber and/or the settling chamber serves the same purpose, in particular the prevention of foam formation and the settling of the fluid in this chamber.

It is preferably provided in this solution, as well, for the fluid retaining element to divide the volume for the brake fluid into small-volume storage areas.

Such small-volume storage areas preferably have the same dimensions and the same purpose as the small-volume storage areas which are described in conjunction with the fluid retaining element in the reserve chamber.

Moreover, such a fluid retaining element in the intake chamber and/or the settling chamber can be constructed and designed in the same way as that described in conjunction with the fluid retaining element for the reserve chamber.

Alternatively or in addition to the provision of a fluid retaining element, an additional solution provides for volume dividers to be provided in the intake chamber and/or the settling chamber.

Volume dividers of this type can be designed in the same way as that described in conjunction with the volume dividers in the reserve chamber.

When providing volume dividers in the intake chamber and/or the settling chamber it is provided, in particular, for these volume dividers to be held on the container body, preferably be integrally formed in one piece on the container body.

Alternatively, it is, however, also possible to integrally form such volume dividers on the separating unit, for example.

Such volume dividers in the intake chamber and/or the settling chamber also serve the same purpose as that described in conjunction with the volume dividers in the reserve chamber; in particular, such volume dividers bring about a division of the volume for the brake fluid into partial volumes so that the brake fluid is settled as a result of the division into partial volumes, which are then located between the volume dividers, and coupled to the container body with respect to its movement so that any free movement of the brake fluid can be suppressed.

Volume dividers in the intake chamber and/or the settling chamber are appropriate, in particular, since they make it easier in a simple manner for bubbles to rise in the brake fluid essentially in an unhindered manner contrary to the force of gravity and, therefore, to be removed in a simple manner from the intake chamber and/or the settling chamber so that, as a result, it is likewise possible to prevent any foam formation whatsoever in the area of the intake chamber and/or the settling chamber, even when bubbles from the hydraulic system have to migrate through the intake chamber and the settling chamber.

For this reason, one advantageous solution provides, for example, for volume dividers to be provided in the intake chamber and/or the settling chamber whereas a fluid retaining element is preferably arranged in the reserve chamber.

It is, however, also possible, with a suitable configuration, to provide a fluid retaining element in the intake chamber and/or the settling chamber whereas volume dividers are provided in the reserve chamber.

In addition, the invention relates to a hydraulic actuating device, in particular a brake actuating device for motor vehicles, comprising a base housing and an actuating cylinder as well as an afterflow reservoir, wherein, in accordance with the invention, the afterflow reservoir is designed in accordance with one of the embodiments described above.

Additional features and advantages of the invention are the subject matter of the following description as well as the drawings illustrating several embodiments.

### BRIEF DESCRIPTION OF THE DRAWINGS

FIG. 1 shows a perspective view of a first embodiment of a brake actuating device according to the invention;

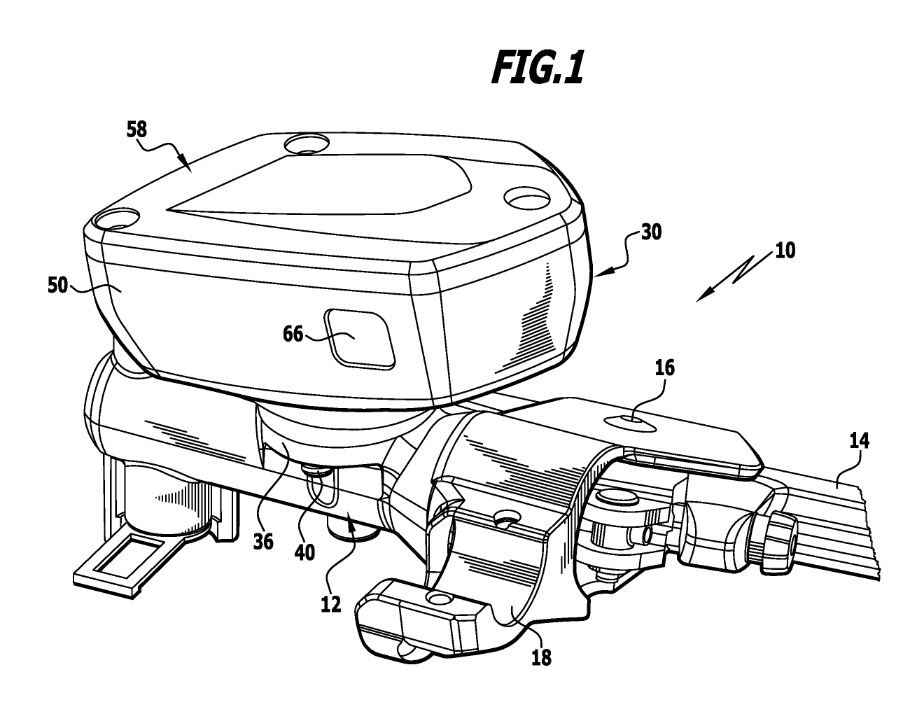

FIG. 2 shows a section along line 2-2 in FIG. 3 through the first embodiment of the brake actuating device according to the invention;

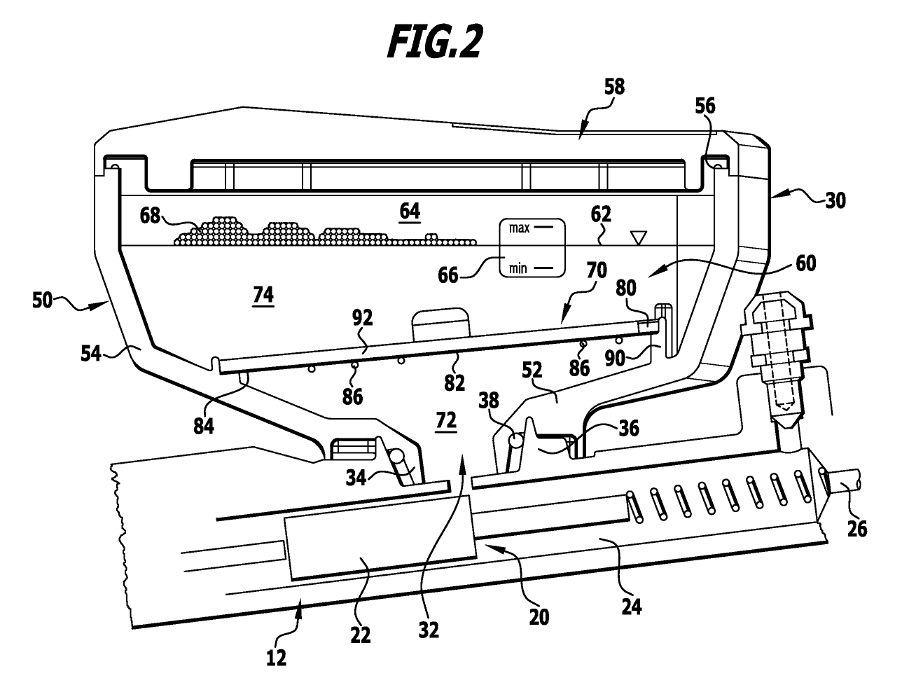

FIG. 3 shows a plan view of an afterflow reservoir with lid removed;

FIG. 4 shows a section similar to FIG. 2 through a second embodiment of an actuating device according to the invention;

FIG. 5 shows a plan view of the second embodiment similar to FIG. 3;

FIG. 6 shows a plan view similar to FIG. 5 with cover of the separating unit removed;

FIG. 7 shows a section similar to FIG. 2 through a third embodiment of an actuating device according to the invention;

FIG. 8 shows a section similar to FIG. 4 through a fourth embodiment of an actuating device according to the invention;

FIG. 9 shows a plan view of the fourth embodiment similar to FIG. 5 and

FIG. 10 shows a plan view of the fourth embodiment similar to FIG. 6.

### DETAILED DESCRIPTION OF THE INVENTION

One embodiment of a brake actuating device 10 for motor vehicles according to the invention, in particular for motor vehicles steered by handlebars, comprises a base housing 12, on which a brake lever 14 is mounted so as to be pivotable about a pivot axis 16.

The base housing 12 can be secured to handlebars of a vehicle steered by handlebars by means of a holder 18 such that the brake lever 14 can be pivoted during actuation in the direction of a handle of the handlebars.

An actuating cylinder 20 can be acted upon with the brake lever 14, namely such that its pressure piston 22 can be displaced, thereby reducing a volume of a cylinder chamber 24, in order to increase the pressure prevailing in a hydraulic system connected to the cylinder chamber 24 and in order to, as a result, actuate a brake cylinder which is not illustrated in the drawings in order to brake the vehicle.

In order to always be able to provide the cylinder chamber 24 and the hydraulic system 26 with sufficient hydraulic fluid, in particular brake fluid, an afterflow reservoir 30 is arranged on the base housing 12 and this has an outlet 32, from which brake fluid can enter the cylinder chamber 24, namely always when the actuating cylinder 20 is not actuated, so that this is always filled completely with brake fluid and no air bubbles, which would reduce the braking action on account of the compressibility of the air, can settle in it.

The outlet 32 is preferably designed as an outlet connection piece 34 which is inserted into a holding projection 36 of the base housing 12 and is seated in the holding projection 36 in a sealed manner with a circumferential seal 38, wherein the afterflow reservoir 30 is fixed in place in the holding projection 36 by means of anchoring rods 40.

A container body 50, which rises above the outlet 32, adjoins the outlet connection piece 34 and following the outlet connection piece 34 widens first of all with a container base 52 adjoining the outlet connection piece and then rises above the container base 52 with side walls 54, namely as far as a filling opening 56 which can be closed by a lid 58.

A storage chamber for hydraulic fluid, which is designated as a whole as 60, is provided in the container body 50 and extends from the outlet 32 and the container base 52 as far as a fluid level 62 and an air chamber 64 is located above the storage chamber 60 so that in a normal, regular operating state the position of the fluid level 62 within predetermined operating state limits is apparent from outside, for example through a window 66 and, therefore, it is apparent whether sufficient brake fluid is present in the container body 50 and, therefore, the storage chamber 60 has a sufficiently large volume.

The vehicles provided with brake actuating devices 10 according to the invention preferably have engines which operate at high rotational speeds and, therefore, transfer vibrations with frequencies corresponding to these rotational speeds to the handlebars and, therefore, also to the base housing 12 and the container body 50.

Vibrations of this type result in the brake fluid forming foam 68 in the area of the fluid level since brake fluid is mixed with the adjoining air in the air chamber 64 and the air bubbles present in the brake fluid have an appreciably long life and so the foam 68 which is formed only breaks down in the resting state.

In order to prevent this foam 68 from entering the cylinder chamber 34 through the outlet 32 and, therefore, the braking action being considerably impaired on account of the compressibility of the air, a separating unit designated as a whole as 70 is provided in the storage chamber 60 and this divides the storage chamber 60 into an intake chamber 72 immediately adjoining the outlet 32 and a reserve chamber 74 located between the separating unit 70 and the fluid level 62.

The separating unit 70 serves the purpose of keeping foam 68 forming in the reserve chamber 74, preferably close to the fluid level 62, away from the intake chamber 72 and, therefore, brake fluid, which is free from air bubbles and foam 68, is always available in the intake chamber 72 for the actuating cylinder 20 to draw in by suction.

On the other hand, it is necessary to replace the amount of brake fluid which is drawn in by the actuating cylinder 20 from the intake chamber 72 by suction with brake fluid from the reserve chamber 74.

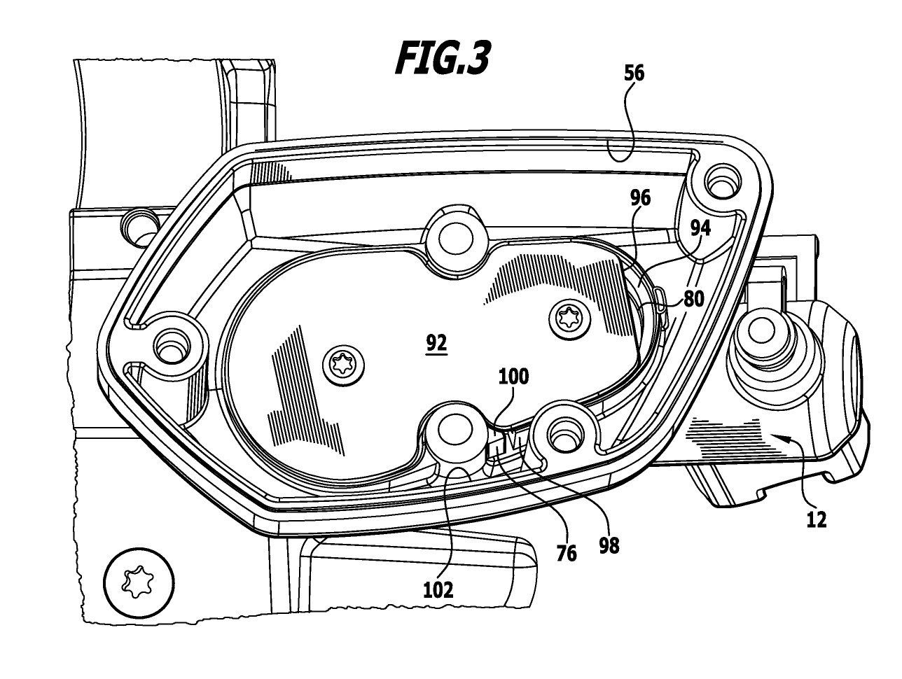

For this reason, a connection 76, through which brake fluid can enter the intake chamber 72 from the reserve chamber 74, is provided between the reserve chamber 74 and the intake chamber 72, as illustrated in FIG. 3.

Since bubbles, which are found in the cylinder chamber 24 and are able to enter the intake chamber 72 from the cylinder chamber 24 via the outlet 32, can also form in the hydraulic system 26 for various reasons, for example also on account of leakages, the separating unit 70 is provided with a bubble exit opening 80, through which bubbles can enter the reserve chamber 74 from the intake chamber 72 and can, therefore, exit in the direction of the fluid level 62.

So that the bubble exit opening 80 discharges all the air bubbles from the intake chamber 72, the separating unit 70 is provided with a bubble guiding surface 82 which, on the one hand, engages over the entire intake chamber 72 and, proceeding from an edge area 84 which is at a maximum distance from the fluid level 62, extends as far as the bubble exit opening 80 in a constantly rising manner, wherein the bubble exit opening 80 is arranged at a location on the bubble guiding surface 82 which is located closest to the fluid level 62.

As a result, the bubble guiding surface 82 guides all the bubbles 86 containing gas and rising upwards out of the intake chamber 72, in particular air bubbles, to the bubble exit opening 80, through which the air bubbles 86 can leave the intake chamber 72 and pass into the reserve chamber 74.

It is, therefore, possible to remove air bubbles 86 from the intake chamber 72 even when they might be formed in the intake chamber 72.

The separating unit 70 is preferably designed such that it has, on the one hand, side walls 90 which are integrally formed in one piece on the container base 52 and, on the other hand, a cover 92 which is seated on the side wall areas and closes the intake chamber 72 upwards, i.e. in the direction of the fluid level 62, and forms the bubble guiding surface 82 on its side facing the intake chamber 72.

The cover 92 borders directly on the bubble exit opening 80 which, as illustrated in FIG. 3, is located between one of the wall sections 94 and an edge 96 of the cover 92.

Furthermore, one wall section 98 is provided with a passage 100 which represents the connection 76, wherein the passage 100 is arranged to the side of the outlet 32 and preferably reaches as far as a lowest-lying area 102 of the afterflow chamber 74 in order to ensure, even if the fluid level 62 were to drop considerably, that the brake fluid present in the reserve chamber essentially passes into the intake chamber 72.

Since the passage 100 is arranged in the lowest-lying area 102 of the reserve chamber 74, it is likewise ensured that the probability of foam 68 and/or air bubbles 86 being present in this area is very small and so the intake chamber 72 is always replenished with an essentially foam-free and bubble-free brake fluid.

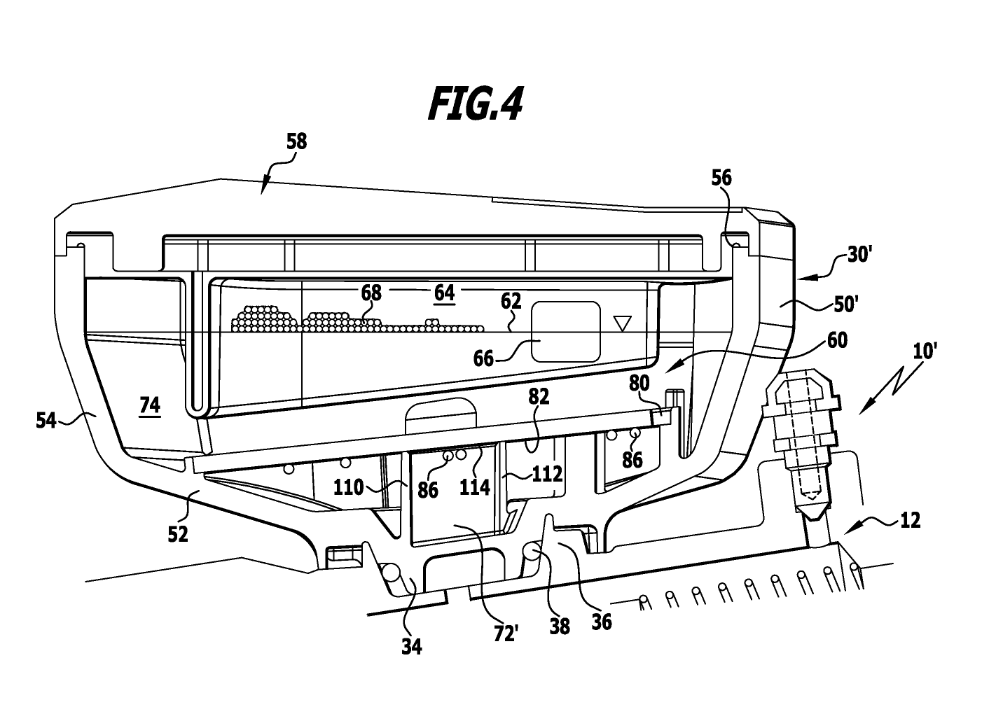

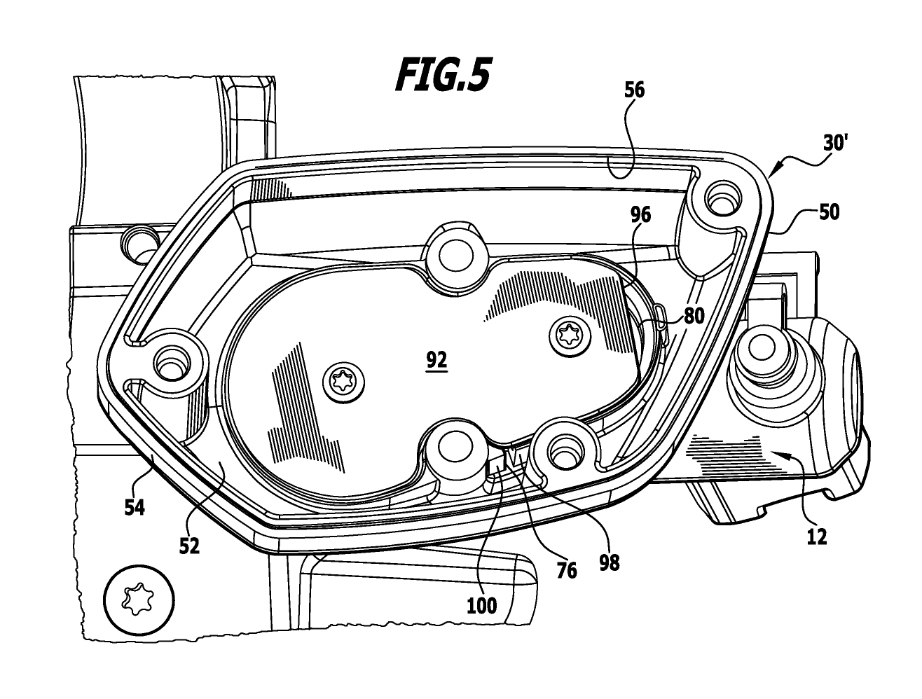

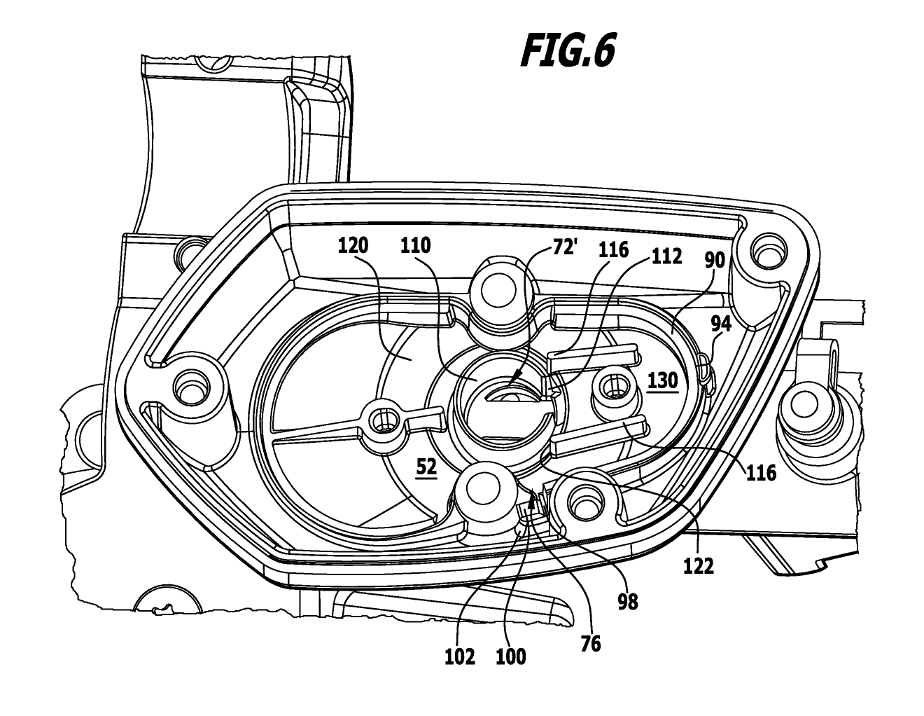

In a second embodiment of a brake actuating device 10′ according to the invention, illustrated in FIGS. 4 to 6, the afterflow reservoir 30′ is provided with the same reference numerals insofar as the same parts are used and so reference can be made in full to the comments on the first embodiment of the afterflow reservoir according to the invention.

In contrast to the first embodiment of the afterflow reservoir 30 according to the invention, the intake chamber 72′ of the second embodiment of the afterflow reservoir 30′ according to the invention is enclosed beneath the separating unit 70 by a dividing unit 110, which rises from the container base 52 and is integrally formed on it, from a settling chamber 120 which surrounds the dividing unit 110, extends as far as the side walls 90 of the separating unit 70 and, in particular, adjoins the passage 100 so that brake fluid entering through the passage 100 reaches the settling chamber 120 first of all and, in it, it is possible for air bubbles possibly still present in this brake fluid to rise upwards and reach the bubble guiding surface 82 and be guided by it to the bubble exit opening 80.

The dividing unit 110 surrounding the intake chamber 72′ has an opening 112 which is arranged so as to face the bubble exit opening 80 and, therefore, offers the possibility for bubbles 86, which rise up in the intake chamber 72′, to reach an area 114 of the bubble guiding surface 82 which engages over the intake chamber 72′ and then, along the bubble guiding surface 82, to have the possibility of moving in the direction of the bubble exit opening 80 in order to leave the intake chamber 72′.

Furthermore, dividing walls 116 are provided adjoining the opening 112 and they likewise separate an area of the intake chamber 72′ extending beyond the opening 112 from the settling chamber 120 and, in particular, likewise lead to bubbles, which form in the settling chamber 120, being moved in the direction of the bubble exit opening 80.

Preferably, both the intake chamber 72′ and the settling chamber 120 merge into a bubble collection chamber 130 which is located between the container base 52 and the bubble guiding surface 82 as well as the bubble exit opening 80 but outside the intake chamber 72′ and the settling chamber 120 so that the air bubbles 86, before they pass through the bubble exit opening 80, are moved out of the intake chamber 72′ to such an extent that they cannot be drawn in by the actuating cylinder 20.

Furthermore, a passage 122 is provided each time between the dividing wall 90 close to the opening 112 and each of the dividing walls 116 and this allows brake fluid to pass from the settling chamber 120 into the intake chamber 72′, wherein the brake fluid then has the possibility of entering the area of the intake chamber 72′ enclosed by the dividing unit 110 via the opening 112.

In this embodiment, the connection 76 between the reserve chamber 74 and the intake chamber 72′ therefore runs first of all through the passage 100 into the settling chamber 120 and from the settling chamber 120 via the passages 122 into the intake chamber 72′.

As for the rest, the second embodiment functions in the same way as the first embodiment and so in this respect reference can be made in full to the comments on the first embodiment.

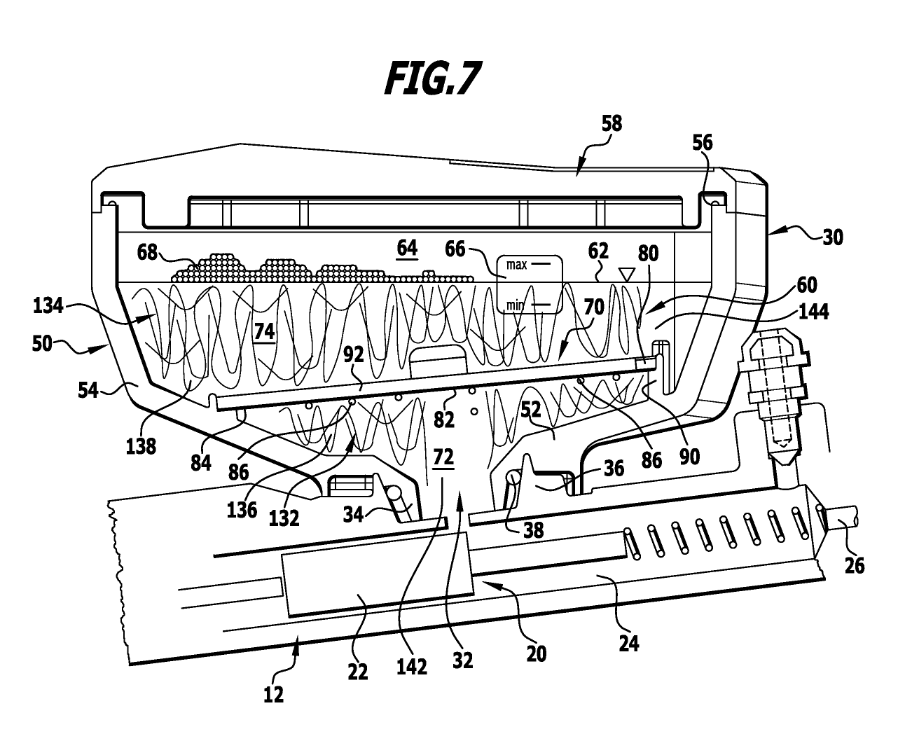

In a third embodiment, illustrated in FIG. 7, additional fluid retaining elements 132, 134 are provided in the intake chamber 72 and in the reserve chamber 74 and form small-volume storage areas 136, 138 which are connected to one another, are, in particular, smaller than 0.5 cm³, even better smaller than 0.2 cm³, and in which the brake fluid is held and which brake any free movement of the fluid in order to reduce or prevent any formation of foam.

The fluid retaining elements 132, 134 can advantageously have connecting channels between them of such a small volume that the foam 68 is held back and cannot propagate into the bath of brake fluid which reaches as far as the fluid level 62.

In order not to prevent the rise of air bubbles from the hydraulic system 26, the fluid retaining elements 132, 134 have passages 142, 144 for rising bubbles, wherein the passage 142 is located above the outlet connection piece 34 and the passage 144 is located above the bubble exit opening 80.

The fluid retaining elements 132, 134 are preferably formed from a braided material, a knitted material, a knit fabric or a woven fabric which can, for example, be laid in folds or simply folded statistically in order to form the storage areas 136, 138.

The braided materials, knitted materials, knit fabrics or woven fabrics preferably consist of threads, fibers or strands consisting of plastic carbon fibers or metal.

Alternatively thereto, it is, however, also conceivable to use large-pored and open-pored members consisting of carbon fibers or plastic or metal for the fluid retaining elements 132, 134.

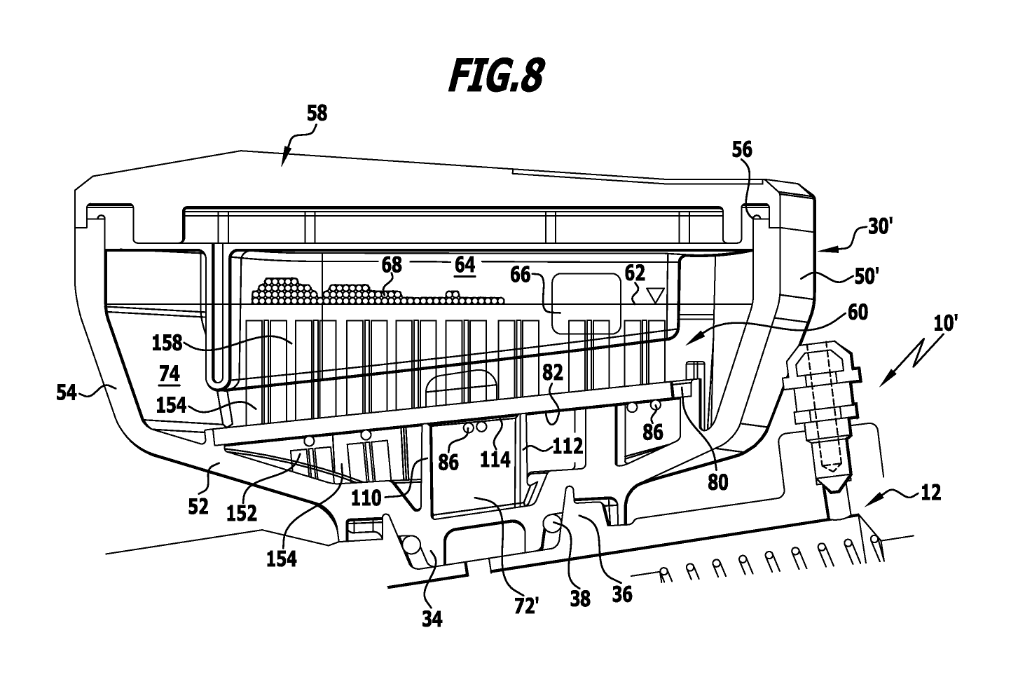

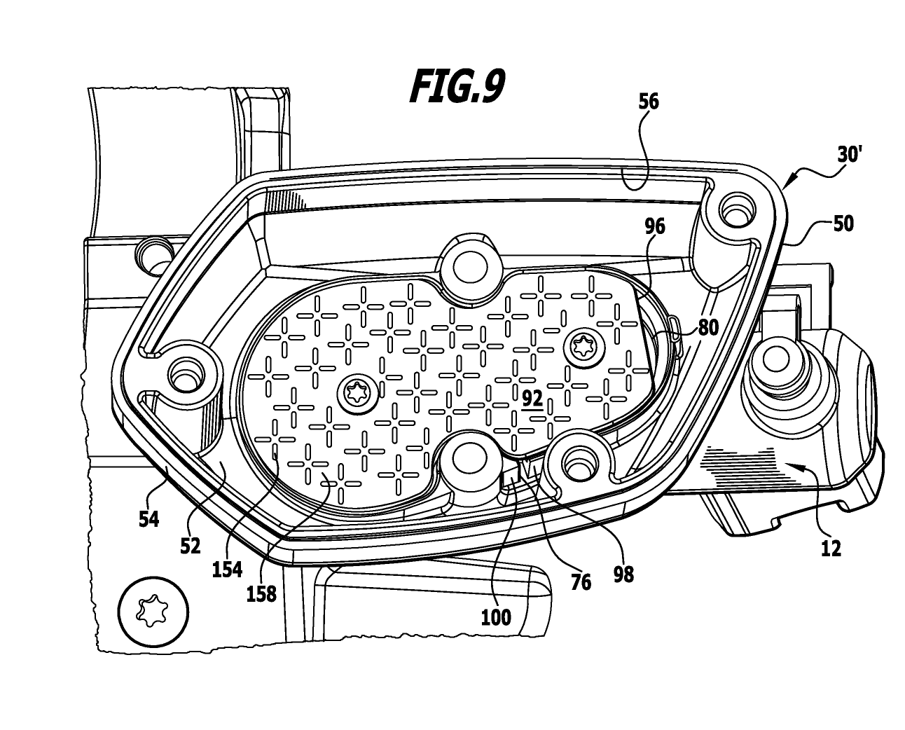

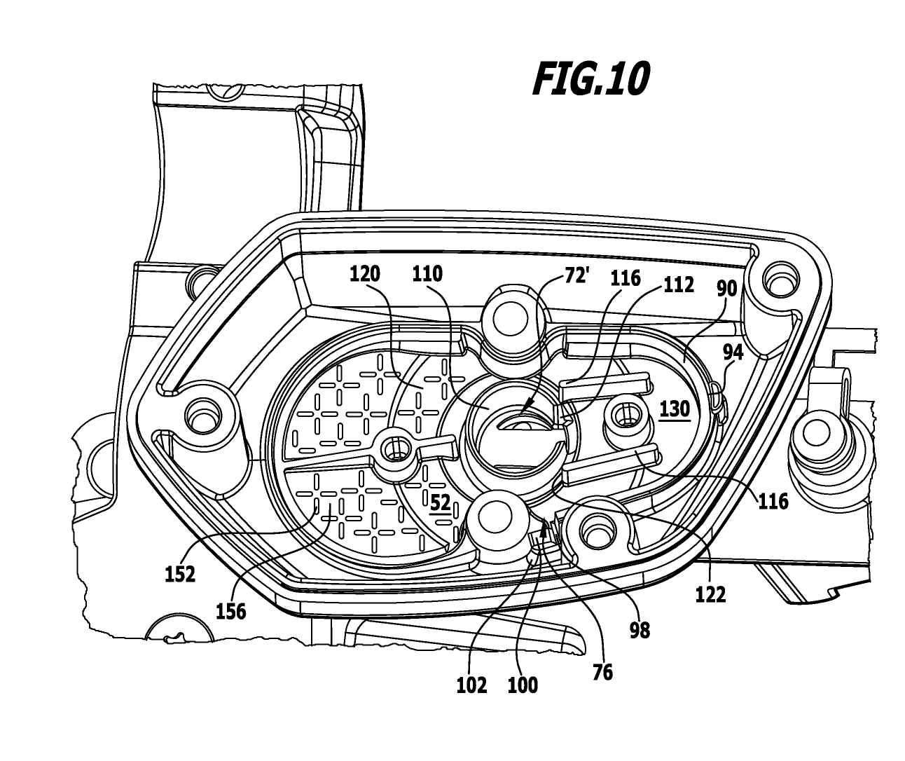

In a fourth embodiment, illustrated in FIGS. 8 to 10, volume dividers 152 are provided in the settling chamber 120 and volume dividers 154 are provided in the reserve chamber 74 for preventing any free movement of the brake fluid, wherein the volume dividers 152 are held on the container base 52, preferably integrally formed thereon in one piece, and extend in the direction of the separating unit 70 whereas the volume dividers 154 are integrally formed on the separating unit 70 and extend in the direction of the fluid level 62.

The volume dividers 152, 154 are designed, for example, as wall sections, webs or columns and divide the respective volume into partial volumes 156, 158 which are connected to one another so that the brake fluid in these partial volumes 156, 158 has less of a tendency to move freely and form foam.

Also, bubbles present in them can expand into other partial volumes 156, 158 only with difficulty or not at all but only rise contrary to the force of gravity.

Furthermore, the volume dividers 152, 154 are designed, in particular, such that they have smooth walls, along which bubbles can rise in an unhindered manner contrary to the force of gravity and, therefore, exit from the intake chamber 72 and the reserve chamber 74, respectively.

In addition, the partial volumes 156, 158 are dimensioned such that the brake fluid can be deposited in the direction of the force of gravity without any hindrance and, therefore, when necessary, can run on in the direction of the outlet connection piece 34.

A propagation of foam 68 into the bath of brake fluid may be reduced or even prevented, in particular, in the reserve chamber 74 with the volume dividers 154.

1. Afterflow reservoir for a hydraulic actuating device, in particular for a clutch or brake actuating device of motor vehicles, comprising an outlet adapted to be connected to an actuating cylinder, a container body rising above the outlet and comprising a storage chamber provided in it for holding hydraulic fluid as well as an air chamber located above a fluid level limiting the storage chamber, a separating unit arranged in the storage chamber, said separating unit extending at a distance from the fluid level and dividing the storage chamber into an intake chamber bordering on the outlet and a reserve chamber located between the separating unit and the fluid level wherein hydraulic fluid can enter the intake chamber from the reserve chamber through at least one connection between the reserve chamber and the intake chamber.

2. Afterflow reservoir as defined in claim 1, wherein the connection is arranged close to the base of the reserve chamber.

3. Afterflow reservoir as defined in claim 1, wherein the separating unit has an exit opening for bubbles opening into the reserve chamber.

4. Afterflow reservoir as defined in claim 1, wherein the separating unit has a bubble guiding surface guiding bubbles rising in the intake chamber to the bubble exit opening.

5. Afterflow reservoir as defined in claim 4, wherein proceeding from an edge area at a maximum distance from the fluid level the bubble guiding surface extends from the fluid level as far as the bubble exit opening at an ever decreasing distance from the fluid level.

6. Afterflow reservoir as defined in claim 4, wherein the bubble exit opening is positioned at a spot on the bubble guiding surface located closest to the fluid level.

7. Afterflow reservoir as defined in claim 4, wherein the separating unit engages over the outlet with its bubble guiding surface.

8. Afterflow reservoir as defined in claim 3, wherein the bubble exit opening is arranged in an area of the separating unit located at a distance from the outlet in a direction parallel to the fluid level.

9. Afterflow reservoir as defined in claim 1, wherein the connection comprises a settling chamber for hydraulic fluid flowing to the intake chamber.

10. Afterflow reservoir as defined in claim 9, wherein the settling chamber is separated from the reserve chamber by the separating unit.

11. Afterflow reservoir as defined in claim 9, wherein both the settling chamber and the intake chamber extend as far as a bubble guiding surface.

12. Afterflow reservoir as defined in claim 9, wherein the bubble guiding surface guides the rising bubblers to the bubble exit opening not only with its area engaging over the intake chamber but also with its area engaging over the settling chamber.

13. Afterflow reservoir as defined in claim 1, wherein the intake chamber merges into a bubble collection chamber arranged in the area of the bubble exit opening.

14. Afterflow reservoir as defined in claim 9, wherein the settling chamber merges into a bubble collection chamber arranged in the area of the bubble exit opening.

15. Afterflow reservoir as defined in claim 1, wherein the separating unit has a cover forming a bubble guiding surface.

16. Afterflow reservoir as defined in claim 1, wherein a cover for the separating unit is part of an insert member inserted into the container body.

17. Afterflow reservoir as defined in claim 1, wherein the separating unit has side walls.

18. Afterflow reservoir as defined in claim 1, wherein at least one side wall of the separating unit is integrally formed on the container body.

19. Afterflow reservoir as defined in claim 9, wherein the intake chamber and the settling chamber are separated from one another by at least one dividing element.

20. Afterflow reservoir as defined in claim 19, wherein the at least one dividing element extends from the container base as far as the bubble guiding surface.

21. Afterflow reservoir as defined in claim 1, wherein a fluid retaining element is arranged in the reserve chamber.

22. Afterflow reservoir as defined in claim 21, wherein the fluid retaining element divides the volume for the brake fluid into small-volume storage areas.

23. Afterflow reservoir as defined in claim 1, wherein volume dividers are provided in the reserve chamber.

24. Afterflow reservoir as defined in claim 23, wherein the volume dividers divide the volume for the brake fluid into partial volumes.

25. Afterflow reservoir as defined in claim 1, wherein a fluid retaining element is arranged in the intake chamber and/or the settling chamber.

26. Afterflow reservoir as defined in claim 25, wherein the fluid retaining element divides the volume for the brake fluid into small-volume storage areas.

27. Afterflow reservoir as defined in claim 1, wherein volume dividers are provided in the intake chamber and/or the settling chamber.

28. Afterflow reservoir as defined in claim 27, wherein the volume dividers divide the volume for the brake fluid into partial volumes.

29. Hydraulic actuating device, in particular clutch or brake actuating device for motor vehicles comprising a base housing and an actuating cylinder as well as an afterflow reservoir, wherein the afterflow reservoir is designed in accordance with claim 1.
